(19) United States
(12) Patent Application Publication
(10) Pub. No.: US 2004/0156718 A1
(43) Pub. Date: Aug. 12, 2004

(54) Airless blaster arrangement

(76) Inventor: Josef Artmann, Duelmen (DE)

Correspondence Address: Karl F Milde Jr, Milde & Hoffberg, Suite 460, 10 Bank Street, White Plains, NY, 10606, US

(21) Appl. No.: 10/483,653

(22) PCT Filed: Jul. 22, 2002
(86) PCT No.: PCT/DE02/02671

(30) Foreign Application Priority Data
Jul. 23, 2001 (DE) 101358458

(51) Int. Cl. F03B 1/00

(52) U.S. Cl. 415/208.1

(57) ABSTRACT

An airless blaster arrangement (100) for the surface treatment of objects with blasting agents comprising an airless blaster (10) consisting of several radially arranged thrower blades (11) which are secured to at least one side disk (14). An aura (12, 13) for the projection of blasting agents is respectively provided between two thrower blades. A distributor element (20) with a star-shaped cross-section formed by several guide with respect to the airless blaster (10) and is connected thereto in a rotationally fixed manner. One guide rib (21) of the distributor element (20) is respectively joined to a thrower blade (11). A blasting agent guide channel (22) of the distributor element (20) leads into the blasting agent projection area (12).

The invention relates to an airless blaster arrangement for surface treatment of objects with blasting agents with a blasting agent supply tube, an impeller consisting of several radially-arranged thrower blades that are attached to at least one side disk, whereby a blasting agent discharge area is enclosed between each pair of thrower blades.

To treat object surfaces, blasting agent particles are accelerated to a high speed by means of impeller wheels that have an abrasive effect upon impact to the object, i.e., that remove rust, scale, or old paint layers, or that cause a change in structure to surface layers, during shot-peening, for example. The known impeller wheels are so shaped that the blasting agent is guided through a blasting agent supply tube to a distributor or an impeller, so that it is accelerated. The distributor or impeller is surrounded by a stream guide shell aperture that includes a stream guide shell aperture orifice. The blasting agent is transported through the stream guide shell aperture orifice into the inner blasting agent discharge area between the thrower blades. There, it is passed to the outer blasting agent discharge area because of inertia and gravity forces along with the imparted radial speed, and finally to the periphery of the impeller wheel, where it is decelerated by the peripheral speed of the edge of the impeller wheel.

Experiments have shown that the flow paths of the blasting agent are influenced by strong turbulence within the interior of a blast turbine, and strongly deviate from the flow relationships of the assumed model and the design of the known airless blaster arrangement. These turbulences strongly brake the motion of the blasting agent within the airless blaster arrangement, and also cause increased wear because of strong scattering. Thus, wear of the theoretically blasting agent-free rear sides of the thrower blades may be found which is attributed to chaotic motion of the blasting agent, particularly in the blasting agent discharge area between two thrower blades.

This problem is also based on the conventional airless blaster arrangement disclosed in the German Patent No. DE 195 36 723 A1. This reference recommends implementing the impeller as an auxiliary impeller wheel. This achieves an eccentric supply of the blasting agent. The blasting agent should move along a circular path before its entry into the blasting agent discharge area, and should perform a spiral-shaped movement upon leaving the distributor through the stream guide shell aperture orifice, whereby impact of the blasting agent onto the thrower blades is to be substantially prevented. Additional auxiliary thrower blades are necessary for the further channeling of the movement of the blasting agent, based on the state of the art, by means of which the number of wear parts is increased. Also, only this channeling reduces the effects of chaotic blasting agent motion without significantly treating the causes. The stream guide shell aperture is still required in order to influence the position and width of the blasted sector.

The German Patent No. DE 198 38 733 C1 specifies another arrangement based on the principle of an eccentric supply of the blasting agent in which the supply aperture of the blasting agent supply tube opens eccentrically to the auxiliary impeller wheel so that the blasting agent is transferred directly into the blade chamber of the auxiliary impeller wheel. The above-mentioned disadvantages of a mere weakening of a chaotic blasting agent motion and the requirement for a stream guide shell aperture also apply in this case.

It is therefore the object of the invention to develop a airless blaster arrangement of the type mentioned at the outset in such manner that the blasting agent is passed via a defined flow motion into the blasting agent discharge area, and friction and wear caused by turbulent motion are reduced.

This object is achieved by the invention in that a distributor with an essentially star-shaped cross-section guide path formed from several guide paths extends coaxially from the impeller wheel and is connected to it so that it cannot rotate, whereby a guide blade of each distributor is connected to a thrower blade of the impeller wheel, and whereby a blasting agent guide channel formed between each guide blade opens into an inner blasting agent discharge area of the impeller wheel.

It has been shown that a positioned flow path may be achieved by eliminating additional elements such as stream guide shell aperture and impeller. The blasting agent passes into the distributor with the eccentrically-positioned stream guide channels and is passed through a longer path. Resultantly, the turbulence still present in the narrow blasting agent guide channels is reduced and the blasting agent is forced into guided movement. Because of the fixed connection against rotation of the distributor and impeller wheel, impact surfaces along the flow direction are avoided after the blasting agent has been guided into the blasting agent guide channels. Instead of this, a slight redirection of the blasting agent is achieved over large radii and angles. The guide blades are directly connected to the thrower blades. The blasting agent guide channels of the distributor open like a funnel into the blasting agent discharge area of the impeller wheel and simulate a natural flow movement.

The following is achieved by the flow of the blasting agent according to the invention: a pre-defined amount of blasting agent is fed in a charge from the supply tube into a blasting agent guide channel. This batch of blasting agent is stored in a designed, pre-determined flow path until entry into the blasting agent discharge area since turbulence no longer occurs, for which it requires a specific, empirically-determined pause interval.

The time point and/or the location at which the batch may be influenced by means of a lateral and/or locally-controlled introduction of blasting agent from the supply tube into one of the blasting agent guide channels at which the batch passes into the blasting agent discharge area and is subsequently impelled. Thus, the stream guide shell aperture to limit the blasted sector, as required according to the state of the art, may be omitted. The flow speed may, for example, may be altered by the rotational speed of the impeller wheel, whereby place and time of the spin-off may be influenced.

In an especially advantageous embodiment of the invention, the blasting agent supply tube is positioned at an angle of 45-90° to the rotation axis and opens at the circumference of the distributor in at least one blasting agent guide channel. Thus, the function of the blasting agent batch occurs simultaneously in one charge. This function may occur very quickly with a rotating distributor: the lateral open blasting agent guide channel, just like a transporting wheel, grabs a batch from the supply tube and continues to rotate. The guide blades extending backwards with the rotation briefly stop the flow out of the supply tube for a moment until the next empty blasting agent guide channel is in front of the supply tube.

Another exemplary embodiment of the invention, in which the blasting agent supply tube may be displaced at least along a batch of the axis of the distributor, is also advantageous. In contrast to changing rotational speed, this possesses the advantage that the effects of a displacement of the supply point may be directly determined, while one must await achieval of the new rotational speed each time the rotational speed is changed.

The quantity of blasting agent that is impelled from each rotating thrower blade, and thereby the sector blasted by the airless blaster arrangement, are influenced by the length of the given batch. It is therefore advantageous if the blasting agent supply tube includes an aperture nozzle whose clear inner diameter is adjustable, so that charges of varying lengths of blasting agent that lead to an alteration in the blasting image length may be stored.

Further advantageous embodiments may be taken form the Dependent claims and the embodiment example explained in the following in more detail with reference to the Figures, which show:

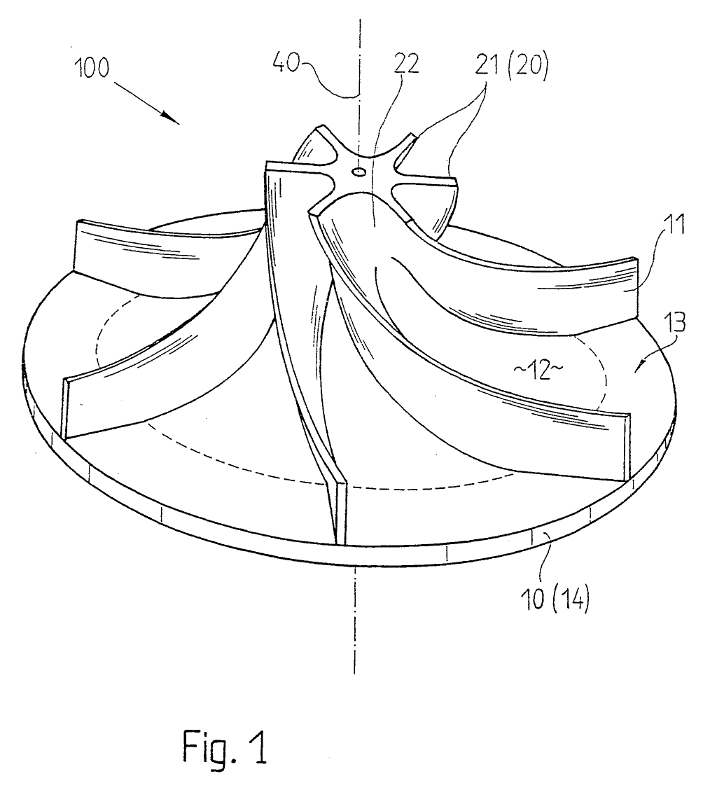

FIG. 1 the airless blaster arrangement based on the invention in a perspective drawing;

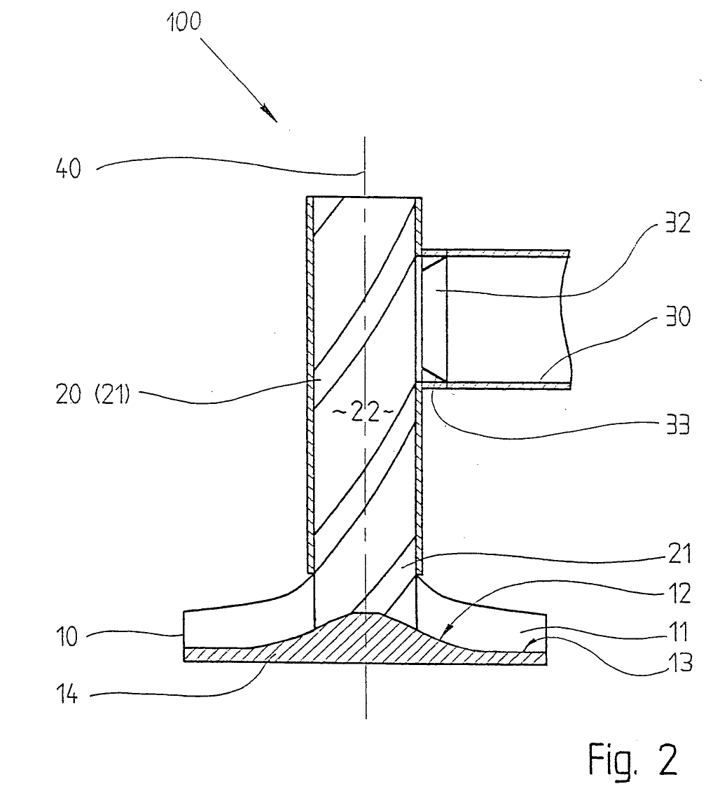

FIG. 2 the airless blaster arrangement seen in cross-section through the rotation axis;

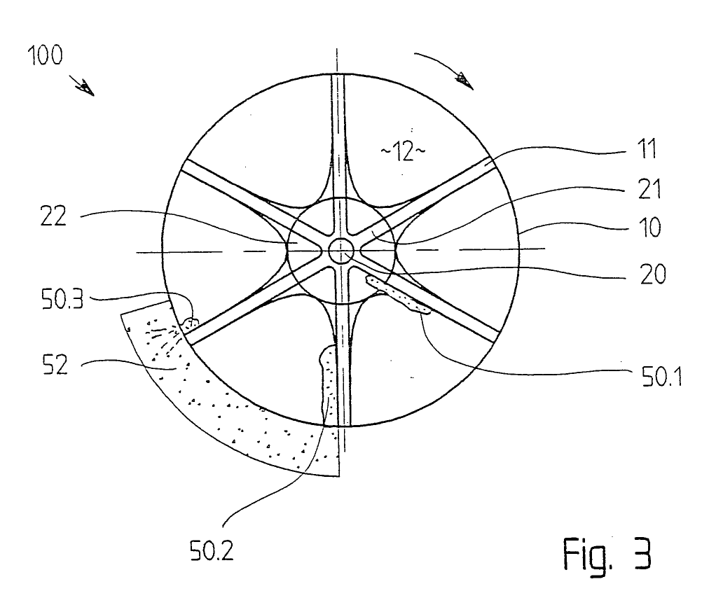

FIG. 3 the airless blaster arrangement in top view, and

As FIG. 1 shows, the guide blades 21 of the distributor 20 extend until they become the thrower blades 11 of the impeller wheel 10. The blasting agent guide channels 22 open as a funnel into an inner blasting agent discharge area 12, each of which is located between thrower blades 11. The smooth, strongly-rounded flow paths allow guided flow of the blasting agent, and do not allow turbulence to form at all. Because of the eccentrically-positioned, relatively narrow blasting agent guide channels 22, the blasting agent is guided along the periphery of the distributor 20 to the impeller wheel 10, and is forced into predetermined flow paths. The inner blasting agent discharge area 12 continues seamlessly into outer blasting agent discharge area 13 that extends as far as the edge of the impeller wheel 10. While the inner blasting agent discharge area 12 is preferably shaped as a type of cavity positioned obliquely with respect to the rotational axis 40, in order to achieve as smooth a transition as possible from the blasting agent guide channels 22 to the inner blasting agent discharge areas 12, the outer blasting agent discharge areas 13 are positioned 90° to the rotation axis in order to ensure that the blasting agent is impelled at a right angle to the rotation axis.

The distributor 20 is preferably in the form of a type of a helical gear wheel or a worm conveyor. It is likewise possible to drill the distributor 20 either along a portion of its length or over the entire length. This achieves the fact that the blasting agent guide channels 22 are positioned oblique to the rotation axis 40, and that an axial forced flow in the direction of the impeller wheel 10 is created in the rotating distributor 20 by the increase of the guide blades 21, even when the rotation axis 40 is positioned horizontally.

FIG. 2 shows the advantageous embodiment example of the airless blaster arrangement 100 in which the blasting agent charge results at the periphery of the distributor 20. A fixed shell tube 32 to which the blasting agent supply tube 30 is connected that includes an aperture surrounds the rotatable distributor 20. The blasting agent supply tube 30 includes a nozzle 32 that itself includes adjustable sheet metal guides 33 in order to be able to adjust the length of the supplied charge of blasting agent. In the position shown in FIG. 2, the nozzle 32 opens into a blasting agent guide channel 22. Upon further rotation of the distributor 20, a guide blade 21 that slides in front of the nozzle briefly interrupts the blasting agent supply. The next blasting agent guide channel 21 is then filled in the same manner.

The impeller wheel 10 is formed together with a coiled distributor 20 as a pump wheel, and, at high speed, operates as an air pump so that blasting agent may be sucked up from the charge point along the blasting agent guide channels 22.

FIG. 3 shows schematically how a blasting agent batch 50.1 flows as a charge from the blasting agent guide channel 22 into the blasting agent discharge area 12 and from there moves along a thrower blade 11. The blasting agent batch 50.2 has already reached the outer circumference of the impeller wheel 10, and begins immediately to spin out. The blasting agent batch 50.3 is almost completely spun out. A blasted sector 52 is formed.

In the embodiment example according to FIG. 3, the distributor 20 is inserted into the impeller wheel 10 as a separate part, and matches it seamlessly. The two parts are so connected together that no rotational displacement of the distributor 20 with respect to the impeller wheel 10 may result. The components may, however, be separated from each other for service or in case of wear. This also applies to the thrower blades 11 which are attached in conventional fashion to the side disk 14 so that it may be removed.

1. Airless blaster arrangement (100) for surface treatment of objects with blasting agent,
with a blasting agent supply tube (30),
with a impeller wheel (10) consisting of several axially-positioned thrower blades (11) that are attached to at least one side disk (14), whereby a blasting agent discharge area (12, 13) is enclosed between each pair of thrower blades (11),
characterized in that a distributor (12) with a star-shaped cross-section formed from several guide blades (21) extends coaxial to the impeller wheel (10) and is connected with it so that it may not rotate, whereby each guide blade (21) of the distributor (20) is connected to a thrower blade (11) of the impeller wheel (10), and whereby a blasting agent guide channel (22) of the distributor (20) formed between each guide blade (21) opens into an inner blasting agent discharge area (12) of the impeller wheel (10).

2. Airless blaster arrangement (100) as in claim 1, characterized in that the blasting agent supply tube is positioned at an angle of from 45°-90° to the rotation axis and that it opens at the circumference of the distributor into at least one blasting agent guide channel.

3. Airless blaster arrangement (100) as in claim 2, characterized in that the blasting agent supply tube (30) may be displaced along at least a part of the axis of the distributor (10).

4. Airless blaster arrangement (100) as in one of claims 2 or 3, characterized in that the blasting agent supply tube (30) includes a port nozzle whose clear inner diameter is adjustable.

5. Airless blaster arrangement (100) as in one of claims 2 through 4, characterized in that the blasting agent supply tube (30) includes a port nozzle whose clear inner height matches the peripheral width of the blasting agent guide channel (22).

6. Airless blaster arrangement (100) as in one of claims 1 through 5, characterized in that the length of the blasting agent guide channels (22) is one to five times the height of the thrower blades (11).

7. Airless blaster arrangement (100) as in one of claims 1 through 6, characterized in that the guide blades (21) are positioned oblique to the rotation axis (40) of the distributor (20) when viewed as a cross-section so that the distributor is formed as a helical gear wheel.

8. Airless blaster arrangement (100) as in one of claims 1 through 6, characterized in that the guide blades of the distributor are so rotated with respect to each other along its length between the axial ends of the distributor so that the distributor possesses a helical shape.

9. Airless blaster arrangement (100) as in one of claims 1 through 8, characterized in that the impeller wheel and the distributor are formed as one part.

10. Airless blaster arrangement (100) as in one of claims 1 through 9, characterized in that the impeller wheel (10) and the distributor (20) are attached to each other so that they can be separated.

11. Airless blaster arrangement (100) as in one of claims 1 through 10, characterized in that the level of the inner blasting agent discharge area (12) is positioned at an angle of from 45°-85° to the rotation axis.

12. Airless blaster arrangement (100) as in one of claims 1 through 11, characterized in that the thrower blades are already formed and are positioned radially on the side disk (14).
